(19) United States
(12) Patent Application Publication
(10) Pub. No.: US 2020/0151404 A1
(43) Pub. Date: May 14, 2020

(54) REUSABLE SHIPPING BOX MANAGEMENT SYSTEM

(71) Applicant: Kuang F. Cheng, Taipei City (TW)

(72) Inventor: Kuang F. Cheng, Taipei City (TW)

(21) Appl. No.: 16/186,587

(22) Filed: Nov. 12, 2018

(51) Int. Cl. G06K 7/10; G06K 19/06; G06K 19/07; G06K 7/14

(52) U.S. Cl. CPC G06K 7/10366; G06K 19/06037; G06K 7/1417; G06K 19/0723; G06K 7/1413; G06K 19/06028

(57) ABSTRACT

A reusable shipping box management system severs to manage reusable shipping boxes by attaching labels to the boxes. Readers on the distribution stations, senders, and receivers serve to read the data on the labels of the reusable shipping boxes and the data are transferred to the network system. Therefore, the status and message of the reusable shipping box are acquired in the processing of storages and sending. The managers may know the status of all the reusable shipping boxes through the network system so that all the reusable shipping boxes may be effectively tracked and managed. Furthermore the reusable shipping box can be reused many times under a precise control.

### FIELD OF THE INVENTION

The present invention is related to reusable shipping boxes, and in particular to a reusable shipping box management system.

### BACKGROUND OF THE INVENTION

With the progress of the community and develop of networks, more and more people use online shopping or other shopping ways through telephones. Therefore, express delivery become more and more important. Many commodities are sent through express delivery, instead of being sold in shops. However, the commodities through on line shopping must be packed in a box for protecting the commodities therein. In current trend, the box is left in the buyer ends instead of being recycled. This will induce the sender end must prepare many boxes for transferring of commodities, while these boxes become waster material and must be treated for protection of environment. This not only induces waste of materials, but also increases costs in manufacturing and environment protection.

Therefore, there is an eager demand for a novel design which can improve above mentioned prior art defects.

### SUMMARY OF THE INVENTION

Accordingly, the object of the present invention is to provide a reusable shipping box management system, wherein by the structure of the present invention, efficiency of the reusable shipping box can be reached to an optimum. No new shipping box is needed. Not only amount of the reusable shipping box may be saved, but also the object of environment protection is achieved. The readers on the distribution stations, senders, and receivers serve to read the data on the labels of the reusable shipping boxes and the data are transferred to the network system. Therefore, the status and message of the reusable shipping box are acquired in the processing of storages and sending. The managers may know the status of all the reusable shipping boxes through the network system so that all the reusable shipping boxes may be effectively tracked and managed. Furthermore the reusable shipping box can be reused many times under a precise control.

To achieve above object, the present invention provides a reusable shipping box management system comprising: a network system having a center network which is installed in a main server; the main server being signally connected to the distribution stations computer devices of the distribution stations so as to form as the network system; at least one distribution station which has a plurality of reusable shipping boxes; each reusable shipping box being installed with a label; the label stores messages about the reusable shipping box and is readable electronically; a sender label reader signally connected to the network system and equipped in the sender of the reusable shipping box; the sender label reader serving to read and record the messages in the label of the reusable shipping box and transferring these messages to the network system; wherein a sender carries the sender label reader and performs the read operation of the label by using the sender label reader; also in transferring of the messages from a buyer end back to the network system, the sender label reader reads the label of the reusable shipping box and transfers to the network system; and at least some or all the labels of the reusable shipping boxes are different.

### BRIEF DESCRIPTION OF THE DRAWINGS

FIG. 1 is a schematic view showing the system of the present invention.

FIG. 2 is a block diagram showing the element of the network system of the present invention.

FIG. 3 is a block diagram showing the structure of the present invention.

FIG. 4 is a schematic view showing that in the present invention, a sender uses a handset as a sender label reader to read the label of a reusable shipping box.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

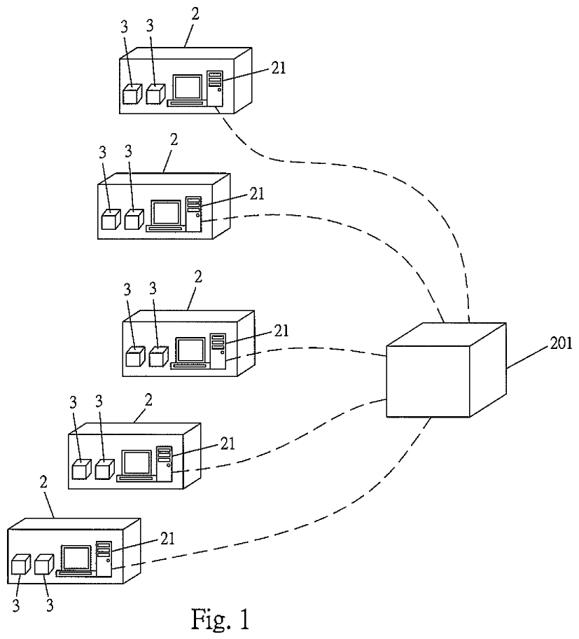

With reference to FIG. 1, a schematic view showing the application of the present invention is illustrated.

A network system 200 includes the following elements.

A center network 250 is installed in a main server 201.

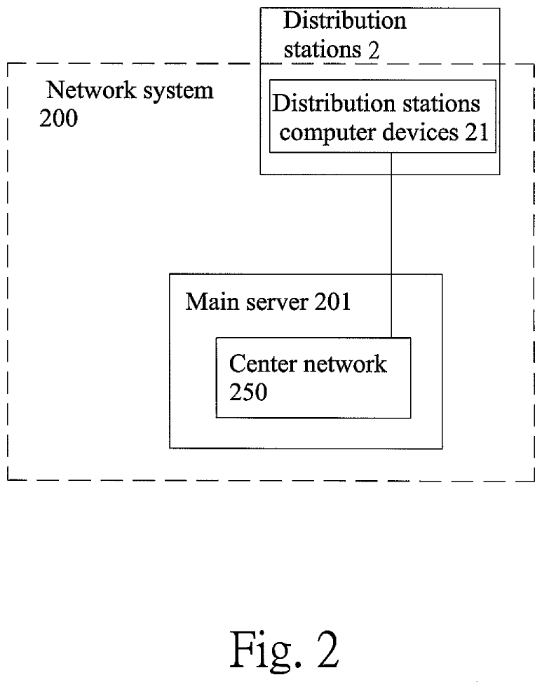

The main server 201 is signally connected to the distribution stations computer devices 21 of the distribution stations 2 so as to form as the network system 200, as illustrated in FIG. 2.

The network system 200 includes different applications which are distributed in different elements of the network system 200, as illustrated in the drawings. However, as known in the art, these applications may be distributed in these elements of the network system 200 by another ways different from those shown in the drawings. All the possible arrangements which can achieve the same functions described in the specification are within the scope of the present invention.

Each of the reusable shipping boxes 3 is installed with a label 31. The label 31 stores messages about the reusable shipping box 3 and is readable electronically. The label 31 is such as a QR code, a barcode, an image identified drawing, an active and passive electronic card, such as an electronic tag, etc. At most some of the labels 31 are different or all of the labels 31 are different.

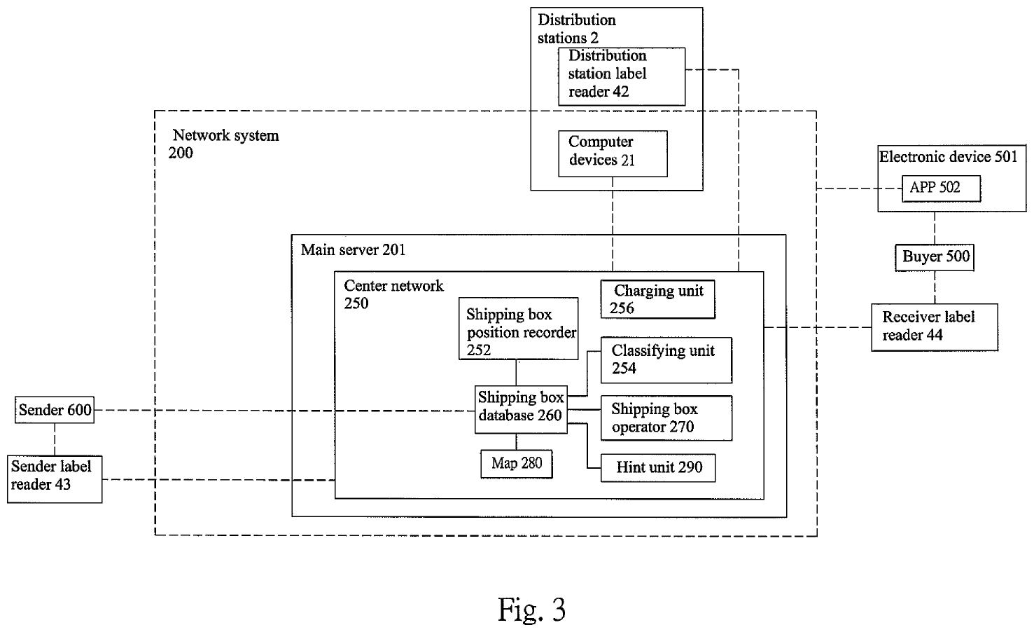

A distribution station label reader 42 is signally connected to the network system 200 and is installed in the distribution station 2 (referring to FIG. 3). The distribution station label reader 42 serves to read and record messages stored in the label 3 of the reusable shipping box 31. The messages about the label 31 and the commodity label 72 are linked in the network system 200. When the commodity 70 has received by a buyer, the network system 200 will disconnect the messages of the reusable shipping box 3 with those of the commodity 70.

A sender label reader 43 is signally connected to the network system 200 and is equipped in the sender of the reusable shipping box 3. The sender label reader 43 serves to read and record the messages in the label 31 of the reusable shipping box 3 and transfers these messages to the network system 200. A sender 600 carries the sender label reader 43 and performs the read operation of the label 31 by using the sender label reader 43. Also in transferring of the messages from the sender end to the network system 200, a position of the sender 600 is also sent to the network system 200 by using GPS or other positioning system. Thereby, the network system 200 knows the position of the reusable shipping box 3.

Furthermore the reusable shipping box 3 may be added with a recycle label 32. By reading the recycle label 32, a message requesting to recycle the reusable shipping box 3 is transmitted from a APP at an electronic device of the buyer 500 to the network system 200 so that the network system 200 may inform the sender 600 to recycle the reusable shipping box 3.

The recycle label 32 stores messages about to recycle the reusable shipping box 3 and is readable electronically. The recycle label 32 is such as a QR code, a barcode, an image identified drawing, an active and passive electronic card, such as an electronic tag, etc. At most some of the recycle labels 32 are different or all of the recycle labels 32 are different.

The buyer 500 may know the messages about the reusable shipping box 3 through the APP in electronic device thereof.

When the sender 600 recycles the reusable shipping box 3, the sender label reader 43 reads the label 31 of the reusable shipping box 3 and transfers the messages to the network system 200 and when the reusable shipping box 3 is sent back to the distribution station 2, the distribution station label reader 42 reads the label 31 of the reusable shipping box 3 and transferred the read data to the network system 200. Thereby, the network system 200 records traces of the reusable shipping box 3 completely.

The network system 200 further includes a classifying unit 254 for classifying recycled reusable shipping boxes 3. Classification of the reusable shipping boxes include to classify the reusable shipping boxes 3 into complete recycled reusable shipping boxes 3 and non-completed recycled reusable shipping boxes 3.

The network system 200 further includes a charging unit 256. If the buyer 500 needs to buy or retain the reusable shipping box 3 or the reusable shipping box 3 cannot be recycled due to a reason from the buyer 500, the network system 200 request the buyer 500 to buy the reusable shipping box 3 and charges to the buyer through the charging unit 256.

A receiver label reader 44 is signally connected to the network system 200. The receiver label reader 44 serves to read and record the messages in the label 31 of the reusable shipping box 3 and transfers these messages to the network system 200. When the reusable shipping box 3 is sent to the receiver 500 (or the buyer 500), the receiver label reader 44 of the receiver 500 reads the label 31 of the reusable shipping box 3 and send the position and status of the reusable shipping box 3 to the network system 200.

The network system 200 stores the data from the label 31 of the reusable shipping box 3 from different readers 42, 43 and 44 to a shipping box database 260.

The network system 200 further includes an shipping box operator 270 which is connected to the shipping box database 260 for performing different operations about the data stored in the shipping box database 260, the operations include the reusing times of the reusable shipping box 3 for determining the lifetime of the reusable shipping box 3.

The shipping box operator 270 further performs the operation about the commodities in the reusable shipping box 3.

The network system 200 further includes a shipping box position recorder 252 for recording positions of the reusable shipping boxes 3 which are further connected to the shipping box database 260. Thereby, users may click a point on a map set by the network system 200 and then the reusable shipping boxes 3 located in the point and related messages will be displayed on the map.

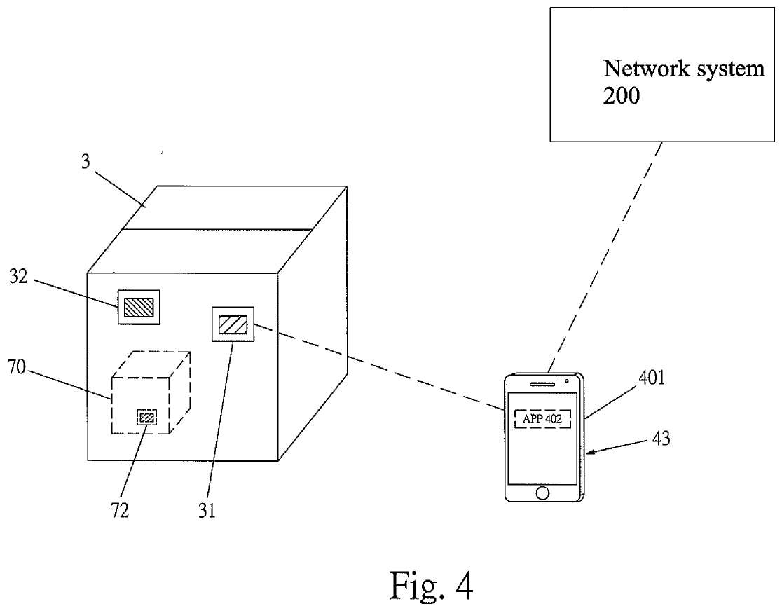

Preferably, the sender label reader 43 and the receiver label reader 44 are performed by using a handset 401 to read the label 31 and then the data read from the label 31 are transferred to the APP 402 in the handset and then the data in the label 31 are transferred to the network system 200, as illustrated in FIG. 4.

The network system 200 further includes a hint unit 290 for informing the users about the status of the system, such as the using times and position of the reusable shipping box 3, data about the commodities transferred by the reusable shipping box 3, etc.

Advantages of the present invention are that: the reusable shipping box 3 is equipped with a label 31 and at least some or all of the data recorded by the labels 3 of the reusable shipping box 3 are different. The reusable shipping boxes 3 may be recycled and sent back to the distribution station 2, and then are classified by a classifying unit 254 for further use. If the receiver 500 does not send back the reusable shipping box 3, the charging unit can charge to the receiver 500.

By the structure of the present invention, the efficiency of the reusable shipping box 3 can be reached to an optimum. No new shipping box is needed. Not only amount of the reusable shipping box 3 may be saved, but also the object of environment protection is achieved. The readers on the distribution stations, senders, and receivers serve to read the data on the labels of the reusable shipping boxes and the data are transferred to the network system. Therefore, the status and message of the reusable shipping box are acquired in the processing of storages and sending. The managers may know the status of all the reusable shipping boxes through the network system so that all the reusable shipping boxes may be effectively tracked and managed. Furthermore the reusable shipping box can be reused many times under a precise control.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A reusable shipping box management system comprising:
a network system having a center network which is installed in a main server;
at least one distribution station which has a plurality of reusable shipping boxes; each reusable shipping box being installed with a label; the label storing messages about the reusable shipping box and is readable electronically; the main server being signally connected to distribution stations computer devices of a plurality of distribution stations;.
a sender label reader signally connected to the network system and equipped in the sender of the reusable shipping box; the sender label reader serving to read and record the messages in the label of the reusable shipping box and transferring these messages to the network system;
wherein a sender carries the sender label reader and performs the read operation of the label by using the sender label reader; also in transferring of the messages from a buyer end back to the network system, the sender label reader reads the label of the reusable shipping box and transfers to the network system; and
at least some or all the labels of the reusable shipping boxes are different.

2. The reusable shipping box management system as claimed in claim 1, wherein a position of the sender is also sent to the network system by using GPS or other positioning system; and thereby, the network system knows the position of the reusable shipping box.

3. The reusable shipping box management system as claimed in claim 1, wherein the network system further includes a classifying unit for classifying recycled reusable shipping boxes; classification of the reusable shipping boxes include to classify the reusable shipping boxes into complete recycled reusable shipping boxes and non-completed recycled reusable shipping boxes.

4. The reusable shipping box management system as claimed in claim 1, wherein the network system further includes a charging unit; if the buyer needs to buy or retain the reusable shipping box or the reusable shipping box cannot be recycled due to a reason from the buyer, the network system requests the buyer to buy the reusable shipping box and charges to the buyer through the charging unit.

5. The reusable shipping box management system as claimed in claim 1, further comprising a distribution station label reader which signally connected to the network system and is installed in the distribution station; the distribution station label reader serves to read and record messages stored in the label of the reusable shipping box.

6. The reusable shipping box management system as claimed in claim 5, wherein the messages about the label of the reusable shipping box and the commodity label about the commodity in the reusable shipping box are linked in the network system; and when the commodity has received by a buyer, the network system will disconnect the messages of the reusable shipping box with those of the commodity.

7. The reusable shipping box management system as claimed in claim 1, further comprising a receiver label reader is signally connected to the network system for reading and recording the messages in the label of the reusable shipping box and transfers these messages to the network system.

8. The reusable shipping box management system as claimed in claim 1, wherein the reusable shipping box is added with a recycle label by reading the recycle label, a message requesting to recycle the reusable shipping box is transmitted from an APP at an electronic device of the buyer to the network system so that the network system informs the sender to recycle the reusable shipping box; wherein the recycle label stores messages about to recycle the reusable shipping box and is readable electronically

9. The reusable shipping box management system as claimed in claim 1, wherein the recycle label is selected form one of a QR code, a barcode, an image identified drawing, an active and passive electronic card, and an electronic tag.

10. The reusable shipping box management system as claimed in claim 1, wherein the network system stores data stored in the label of the reusable shipping box and read from different readers to a shipping box database.

11. The reusable shipping box management system as claimed in claim 10, wherein the network system includes an shipping box operator which is connected to the shipping box database for performing different operations about the data stored in the shipping box database.

12. The reusable shipping box management system as claimed in claim 11, wherein the operations include the reusing times of the reusable shipping box for determining the lifetime of the reusable shipping box.

13. The reusable shipping box management system as claimed in claim 1, wherein the network system further includes a shipping box position recorder for recording positions of the reusable shipping boxes which are further connected to the shipping box database; and thereby, when users click a point on a map set by the network system and then the reusable shipping boxes located in the point and related messages will be displayed on the map.

14. The reusable shipping box management system as claimed in claim 7, wherein the sender label reader and the receiver label reader are performed by using a handset to read the label and then the data read from the label are transferred to the APP in the handset and then the data in the label are transferred to the network system.

15. The reusable shipping box management system as claimed in claim 1, wherein the network system further includes a hint unit for informing the users about the status of the system.

16. The reusable shipping box management system as claimed in claim 1, wherein the label is selected from one of a QR code, a barcode, an image identified drawing, an active and passive electronic card, and an electronic tag.
